(19) United States
(12) Patent Application Publication
(10) Pub. No.: US 2019/0380534 A1
(43) Pub. Date: Dec. 19, 2019

(54) PORTABLE FIRE PIT ASSEMBLY

(71) Applicant: Tony Patterson, Wheeling, WV (US)

(72) Inventor: Tony Patterson, Wheeling, WV (US)

(21) Appl. No.: 16/006,955

(22) Filed: Jun. 13, 2018

(51) Int. Cl. A47J 37/07; B62B 1/18

(52) U.S. Cl. CPC A47J 37/0763; B62B 1/18

(57) ABSTRACT

A portable fire pit assembly for facilitating an open flame to be portable includes a wheelbarrow that has a bucket and a pair of handles. The bucket is comprised of a flame resistant material thereby facilitating the bucket to contain an open flame. The bucket has a plurality of apertures extending therethrough to pass air into the bucket for enhancing combustion. A grill is removably positioned on the wheelbarrow having the grill being positioned over the open flame.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to fire pit devices and more particularly pertains to a new fire pit device for facilitating an open flame to be portable.

### BRIEF SUMMARY OF THE INVENTION

An embodiment of the disclosure meets the needs presented above by generally comprising a wheelbarrow that has a bucket and a pair of handles. The bucket is comprised of a flame resistant material thereby facilitating the bucket to contain an open flame. The bucket has a plurality of apertures extending therethrough to pass air into the bucket for enhancing combustion. A grill is removably positioned on the wheelbarrow having the grill being positioned over the open flame.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a portable fire pit assembly according to an embodiment of the disclosure.

FIG. 2 is an exploded perspective view of an embodiment of the disclosure.

FIG. 3 is an exploded left side view of an embodiment of the disclosure.

FIG. 4 is a bottom view of an embodiment of the disclosure.

FIG. 5 is a cross sectional view taken along line 5-5 of FIG. 4 of an embodiment of the disclosure.

### DETAILED DESCRIPTION OF THE INVENTION

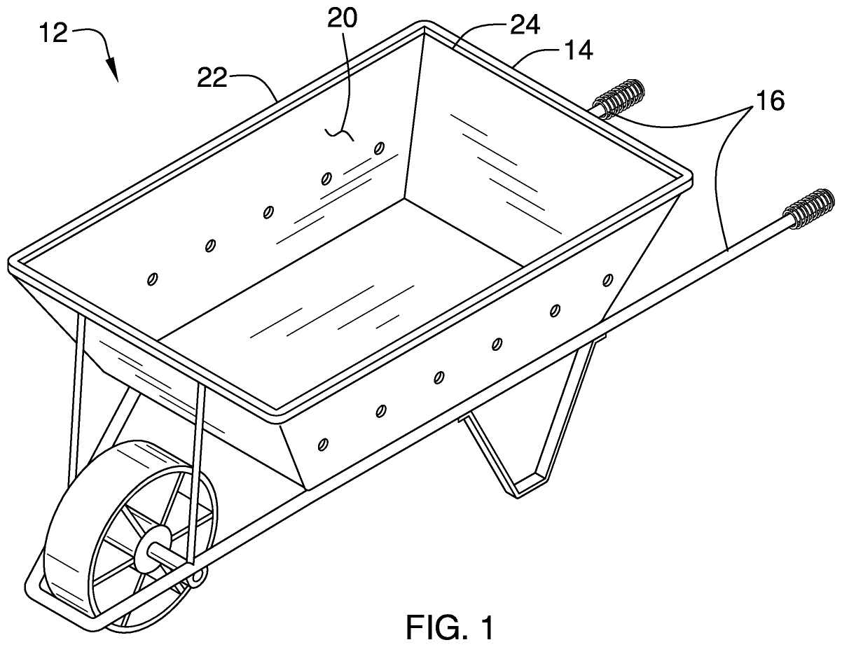

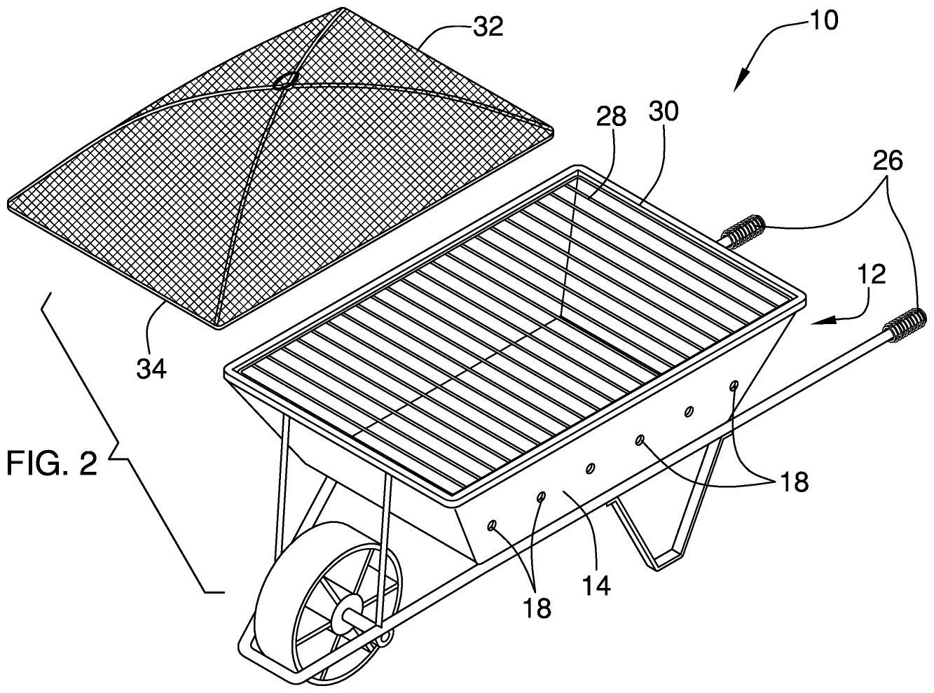

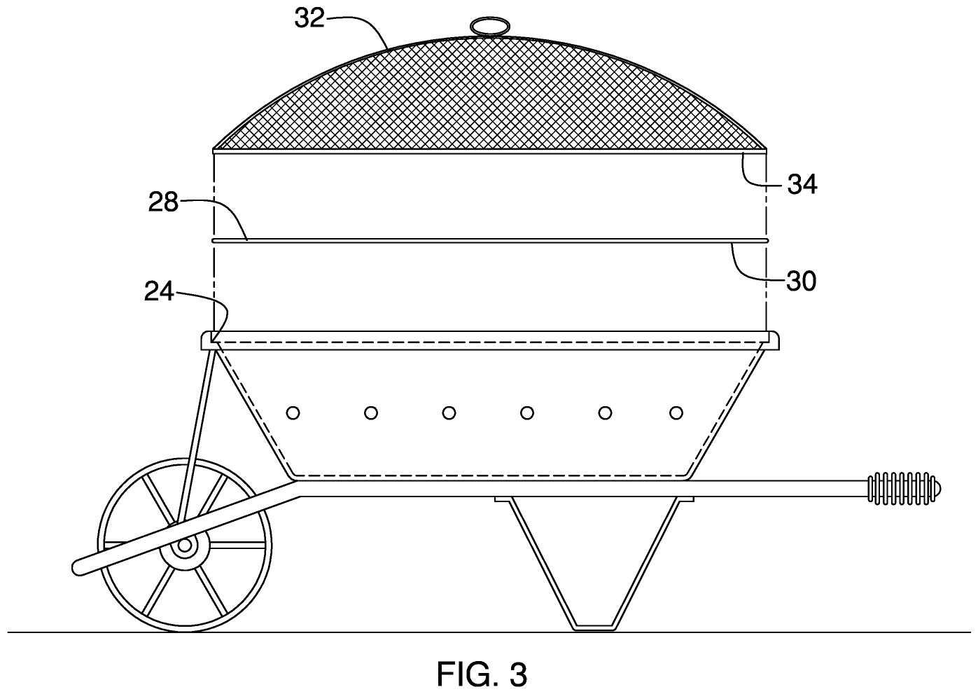

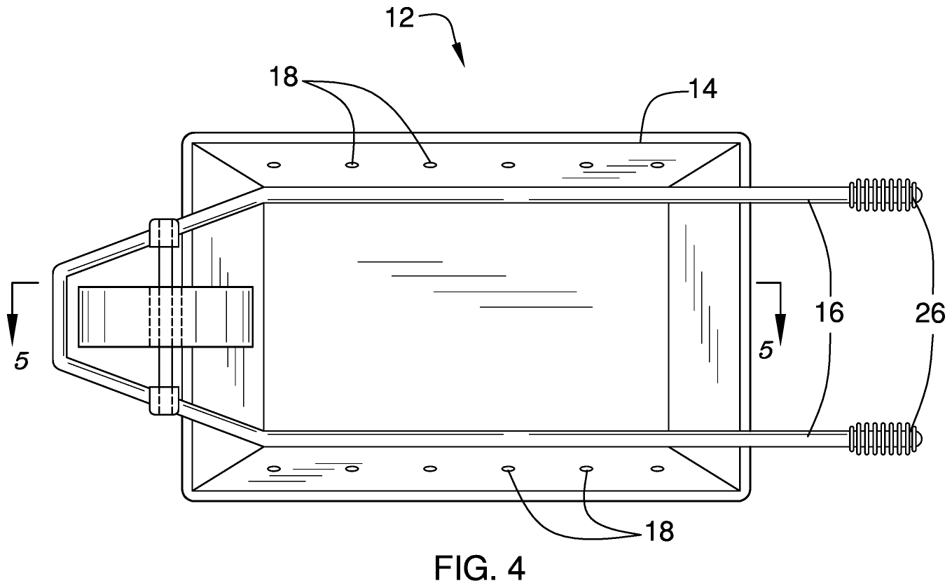

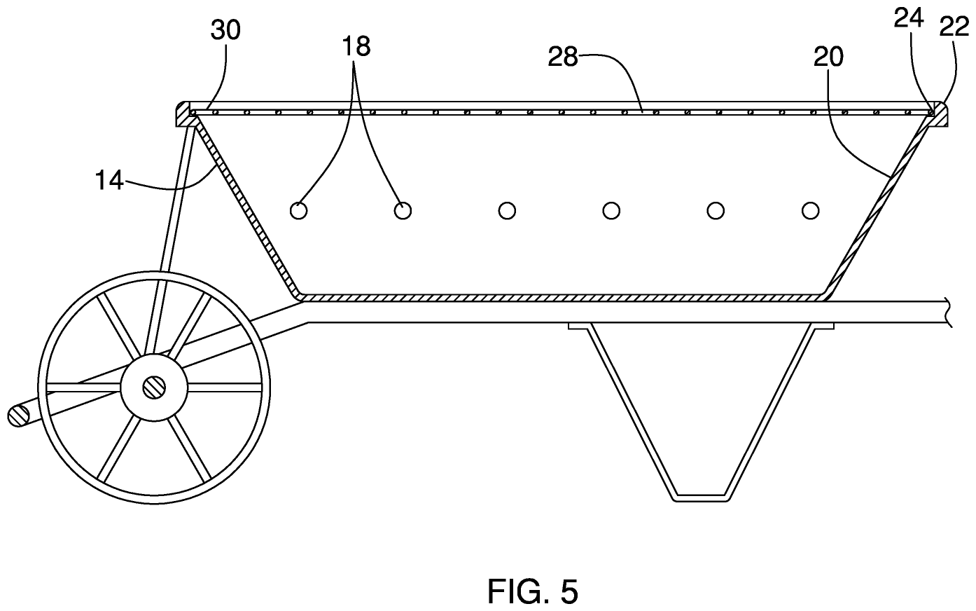

With reference now to the drawings, and in particular to FIGS. 1 through 5 thereof, a new fire pit device embodying the principles and concepts of an embodiment of the disclosure and generally designated by the reference numeral 10 will be described.

As best illustrated in FIGS. 1 through 5, the portable fire pit assembly 10 generally comprises a wheelbarrow 12 that has a bucket 14 and a pair of handles 16. The bucket 14 is comprised of a flame resistant material, such as steel or the like, thereby facilitating the bucket 14 to contain an open flame. Additionally, a wheel on the wheelbarrow 12 may be comprised of a flame resistant material, such as steel or the like, thereby ensuring that the wheel is not damaged by the open flame. The bucket 14 has a plurality of apertures 18 extending therethrough thereby passing air into the bucket 14 for enhancing combustion. The apertures 18 may be spaced apart from each other and be distributed along a first and second lateral side of the bucket 14. The bucket 14 has an inside surface 20 and a top edge 22, the inside surface 20 has a ledge 24 extending around an entire perimeter of the bucket 14, and the ledge 24 is spaced from the top edge 22. The bucket 14 may have a plurality of intersecting sides such that the bucket 14 has a rectangular shape. Alternatively, the bucket 14 may have any conceivable geometric shape that can contain an open flame.

A pair of grips 26 is included and each of the grips 26 is coupled to a respective one of the handles 16 for gripping. Each of the grips 26 is comprised of a thermally insulating material to inhibit thermal communication between the bucket 14 and the grips 26. Thus, a user can move the wheelbarrow 12 without getting burned. The grips 26 may comprise metallic coils that are wrapped around the respective handle or any other type of grip that protects the user's hands from being burned.

A grill 28 is removably positioned on the wheelbarrow 12 having the grill 28 being positioned over the open flame. In this way food can be positioned on the grill 28 for cooking the food over the open flame. The grill 28 has a perimeter member 30 and the perimeter member 30 lies on the ledge 24 when the grill 28 is positioned on the wheelbarrow 12. In this way the grill 28 is retained above the open flame having the grill 28 being horizontally oriented. The perimeter member 30 has a shape that corresponds to the shape of the bucket 14 thereby ensuring that the perimeter member 30 is coextensive with the ledge 24 when the grill 28 is positioned on the wheelbarrow 12.

A cover 32 is provided and the cover 32 is removably positioned on the wheelbarrow 12. The cover 32 is comprised of a mesh material, such as a steel screen or the like, to pass air therethrough to enhance combustion. Additionally, the cover 32 inhibits sparks and burning debris from escaping the wheelbarrow 12. The cover 32 has an outer edge 34 and the outer edge 34 lies on the perimeter member 30 of the grill 28 when the cover 32 is positioned on the grill 28. The cover 32 has a shape that corresponds to the shape of the bucket 14 such that the outer edge 34 of the cover 32 is coextensive with the ledge 24 when the cover 32 is positioned on the wheelbarrow 12. Additionally, the cover 32 may be dome shaped or have any other shape that is common to fire screens.

In use, the wheelbarrow 12 is positioned at a selected location and the open flame is burned in the bucket 14. The wheelbarrow 12 facilitates the open flame to be moved or relocated while the open flame is burning. In this way the wheelbarrow 12 can be positioned to accommodate wind direction or other environmental factors that can affect smoke or create a potential fire hazard. The grill 28 is positionable on the ledge 24 for cooking or for inhibiting people or objects from falling into the open flame. Additionally, the cover 32 is positionable on the ledge 24 to contain sparks and burning debris from the open flame.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable fire pit assembly being configured to contain and transport an open fire, the assembly comprising:
a wheelbarrow having a bucket and a pair of handles, the bucket being comprised of a flame resistant material thereby facilitating the bucket to contain an open flame, the bucket having a plurality of apertures extending therethrough wherein each of the apertures is configured to pass air into the bucket for enhancing combustion; and
a grill being removably positioned on the wheelbarrow having the grill being positioned over the open flame.

2. The assembly according to claim 1, further comprising a pair of grips, each of the grips being coupled to a respective one of the handles for gripping, each of the grips being comprised of a thermally insulating material to inhibit thermal communication between the bucket and the grips thereby facilitating a user to move the wheelbarrow without getting burned.

3. The assembly according to claim 1, wherein:
the bucket has an inside surface and a top edge, the inside surface having a ledge extending around an entire perimeter of the bucket, the ledge being spaced from the top edge; and
the grill has a perimeter member, the perimeter member lying on the ledge when the grill is positioned on the wheelbarrow having the grill being horizontally oriented.

4. The assembly according to claim 3, further comprising a cover being removably positioned on the wheelbarrow, the cover being comprised of a mesh material wherein the cover is configured to pass air therethrough to enhance combustion, the cover having an outer edge, the outer edge lying on the perimeter member of the grill when the cover is positioned on the grill.

5. A portable fire pit assembly being configured to contain and transport an open fire, the assembly comprising:
a wheelbarrow having a bucket and a pair of handles, the bucket being comprised of a flame resistant material thereby facilitating the bucket to contain an open flame, the bucket having a plurality of apertures extending therethrough wherein each of the apertures is configured to pass air into the bucket for enhancing combustion, the bucket having an inside surface and a top edge, the inside surface having a ledge extending around an entire perimeter of the bucket, the ledge being spaced from the top edge;
a pair of grips, each of the grips being coupled to a respective one of the handles for gripping, each of the grips being comprised of a thermally insulating material to inhibit thermal communication between the bucket and the grips thereby facilitating a user to move the wheelbarrow without getting burned;
a grill being removably positioned on the wheelbarrow having the grill being positioned over the open flame, the grill having a perimeter member, the perimeter member lying on the ledge when the grill is positioned on the wheelbarrow having the grill being horizontally oriented; and
a cover being removably positioned on the wheelbarrow, the cover being comprised of a mesh material wherein the cover is configured to pass air therethrough to enhance combustion, the cover having an outer edge, the outer edge lying on the perimeter member of the grill when the cover is positioned on the grill.
